(19) United States
(12) Patent Application Publication
(10) Pub. No.: US 2026/0183679 A1
(43) Pub. Date: Jul. 2, 2026

(54) ROTATABLE TOY SYSTEM

(71) Applicant: 4M Industrial Development Limited, Wan Chai (HK)

(72) Inventors: Chi Keung CHU, Wan Chai (HK); Chi Fung CHAN, Wan Chai (HK)

(21) Appl. No.: 19/006,805

(22) Filed: Dec. 31, 2024

(51) Int. Cl. A63H 33/26; A63F 9/18; A63F 11/00; A63H 3/50; B42D 3/12; G09B 3/06

(52) U.S. Cl. CPC A63H 33/26; A63F 9/18; A63F 11/0011; A63H 3/50; B42D 3/12; G09B 3/06; A63F 2011/0016

(57) ABSTRACT

A rotatable toy system is disclosed. The rotatable toy system comprises a base including a first magnetic member having a first magnetic field; a body connected to the base, the body being rotatable by a user relative to the base to a plurality of indicating orientations; and a supporting seat for rotatably retaining the base and body connected thereto. The seat includes a second magnetic member having a second magnetic field. The first magnetic member interacts with the second magnetic member to move the base and the connected body into a predetermined angular orientation relative to the supporting seat.

### TECHNICAL FIELD

The present disclosure relates to rotatable toy systems, particularly those that utilize magnetic fields to guide and orient components in a predetermined manner.

### BACKGROUND

Toys have been used for entertainment and educational purposes for many years.

However, traditional toys with educational purpose often rely on involvement of adults to maintain engagement or supervision children playing with that toy.

There are some types of educational toys which can be used independently for learning by children. For example, more and more digital interactive toys are used for education and entertainment. However, digital toys may have several disadvantages, including potential addiction, social isolation, eye strain, limited physical development of coordination or motor skills, increased dependence on technology, cyberbullying risks, data collection concerns, stifled creativity and environmental impact.

It is an object of the present disclosure to address or at least partially ameliorate some of the above limitations of the current approaches.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a rotatable toy system. The rotatable toy system may comprise a base, a body connected to the base, a supporting seat and a selecting seat.

The base may include a first magnetic member having a first magnetic field. The body may be rotatable by a user relative to the base to a plurality of indicating orientations. Optionally, the body may be releasably connected to the base.

The supporting seat may rotatably retain the base and body connected thereto. The seat may include a second magnetic member having a second magnetic field. The first magnetic member interacts with the second magnetic member to move the base and the connected body into a predetermined angular orientation relative to the supporting seat.

The selecting seat may be sized and dimensioned to fix the position of the base while permitting rotation of the connected body relative to the base by a user to specify one of the plurality of indicating orientations.

The selecting seat may be positioned within a first planar member having a first plurality of regions defined therein or thereon, said regions displaying at least one indicium. The supporting seat may be positioned within a second planar member comprising a second plurality of regions displaying at least one indicium defined therein or thereon. Each of the indicium of the first plurality of regions may have a corresponding indicium in the second plurality of regions located at a different angular orientation relative to the base.

Optionally, following the rotation by the user of the body relative to the base on the selecting seat to specify a region of the first planar member, the placement of the base and the connected body on the supporting seat causes the first magnetic field of the base to interact with the second magnetic field of the supporting seat so as to move the base and the connected body into a predetermined angular orientation to align the body with one of the second plurality of regions of the second planar member.

Optionally, the indicating orientation of the body in the selecting seat and the supporting seat relative to the base may be unchanged.

A pre-determined pair of indicia may be indicated by: (a) the indicating orientation of the body in the selecting seat denoted by the indicating member of the body pointing towards a first region of the first plurality of region; and (b) the indicating orientation of the body in the supporting seat denoted by the indicating member of the body pointing towards a second region of the second plurality of regions. The pre-determined pair of indicia may comprise one indicium of the first set of indicia on the first planar member and one indicium of the second set of indicia on the second planar member are semantically linked.

The direction of the second magnetic member relative to the supporting seat can be selected from one direction from a plurality of different directions.

The first set of indicia may comprise a plurality of questions; and the second set of indicia may comprise a plurality of semantically linked answers.

Optionally, the first planar member and the second planar member may comprise more than one leaves of a book joined together at a spine.

A cover of the book may comprise a retention member for retaining the base and the connected body on the cover when the book is arranged vertically.

Optionally, the retention member may comprise a portion attracted by the first magnetic member, to retain the base and the connected body on the cover when the book is arranged vertically.

Optionally, the retention member may comprise a recess for receiving a complementary protrusion of the base and thereby retaining the base and the connected body on the cover when the book is arranged vertically.

In accordance with a second aspect of the present disclosure, there is provided a rotatable toy system. The rotatable toy system may comprise a base and a body connected to the base. The base may include a first magnetic member having a first magnetic field. The body may be rotatable by a user relative to the base to a plurality of indicating orientations. The rotatable toy system may also comprise a supporting seat for rotatably retaining the base and body connected thereto. The supporting seat includes a second magnetic member having a second magnetic field. The rotatable toy system may also comprise a selecting seat. The selecting seat may be sized and dimensioned to fix the position of the base while permitting rotation of the connected body by a user relative to the base to specify one of the plurality of indicating orientations. The selecting seat may be positioned within a first planar member having a first plurality of regions, said regions displaying at least one indicium, and the supporting seat may be positioned within a second planar member comprising a second plurality of regions displaying at least one indicium.

Optionally, each of the indicium of the first plurality of regions may have a corresponding indicium in the second plurality of regions located at a different angular position relative to the base.

Following the rotation by the user of the body relative to the base on the selecting seat to specify a region of the first planar member, the placement of the base and the connected body on the supporting seat causes the first magnetic field of the base to interact with the second magnetic field of the supporting seat so as to move the base and the connected body into a predetermined angular orientation to align the body with one of the second plurality of regions of the second planar member.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1A depicts an exemplary toy system according to one embodiment of the present disclosure in which one exemplary body is placed on a selecting seat; together with a supporting seat in an adjacent alternate planar surface shown for reference.

FIG. 1B depicts the exemplary toy system of FIG. 1A showing the body on a supporting seat.

FIG. 1C depicts a schematic interaction between magnetic fields of the seat and the supporting seat of FIG. 1B.

FIG. 2A depicts one embodiment of an exemplary body, in this case a robot figurine.

FIG. 2B depicts an exploded view of the body depicted in FIG. 2A.

FIG. 2C depicts an alternate embodiment of an exemplary body.

FIG. 2D depicts another alternate embodiment of an exemplary body.

FIG. 3A depicts a further embodiment of a toy system according wherein the orientation of a magnetic member of a supporting member is changeable.

FIG. 3B depicts an exemplary orientation of the magnetic member of the supporting member of FIG. 3A.

FIG. 3C depicts another exemplary orientation of the magnetic member of the supporting member of FIG. 3A.

FIG. 4A and FIG. 4B depict exemplary various arrangements of regions corresponding to the different orientations of FIG. 3B and FIG. 3C.

FIG. 5A depicts an alternative toy system in which the body of is held on the cover of a book in a horizontal orientation.

FIG. 5B depicts the exemplary toy system of FIG. 5A in which the body is held on the cover of a book in a vertical orientation.

FIG. 5C depicts an exploded view of the selecting seat of FIG. 5A, an exemplary body and seat.

FIG. 6A depicts an alternative arrangement of toy system of FIG. 5A in which the base and body are retained by an abutment.

FIG. 6B depicts the toy system of FIG. 6A when a body is spaced apart from a holding position

FIG. 6C depicts a partially open view of the toy system of FIG. 6A.

FIG. 6D is a cross sectional view of the toy system of FIG. 6A.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure.

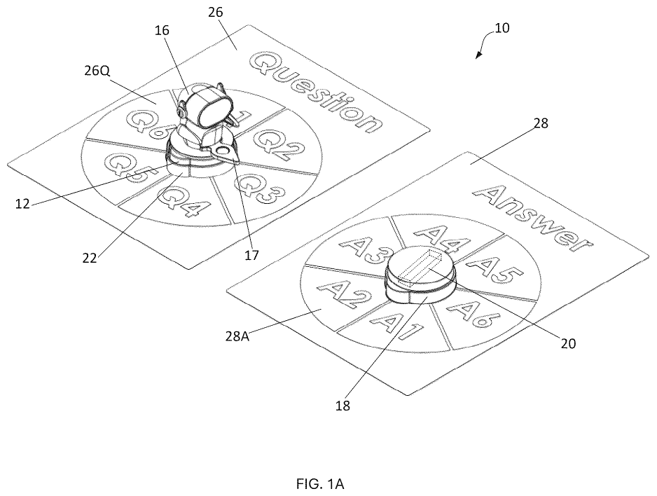

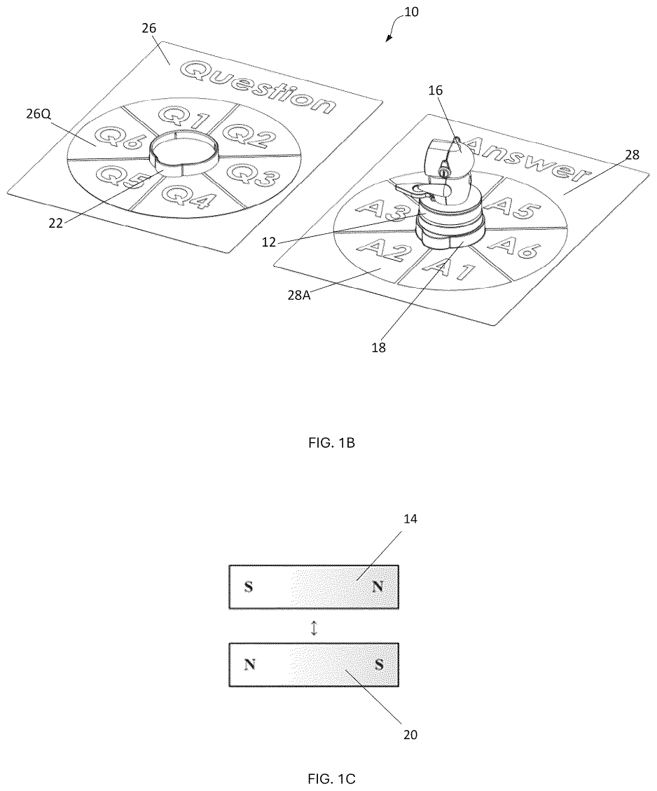

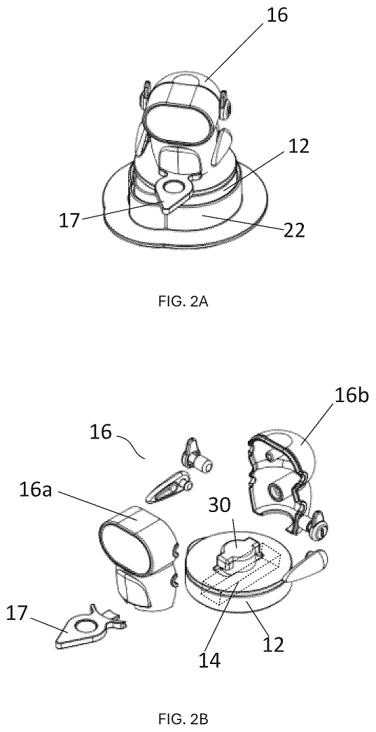

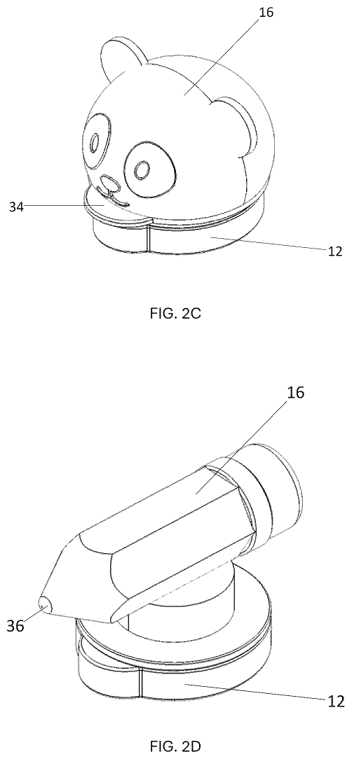

Referring to the drawings, there is shown in FIG. 1A an exemplary rotatable toy system 10 according to one embodiment of the present disclosure. The rotatable toy system 10 comprises a base 12, a body 16 and a supporting seat 18. In some embodiments, the base 12 may include a first magnetic member 14 (as depicted in dotted outline in FIG. 2B) disposed inside the base as depicted in more detail in FIG. 2A, having a first magnetic field. The body 16 may be connected to the base 12.

The supporting seat 18 is configured to retain the base and the connected body connected. The body 16 may be rotatable by a user relative to the retained base 12 when placed in the selecting seat to a plurality of indicating orientations; and the body and base may rotate together when placed in the supporting seat as described further herein.

The body 16 may have an indication member 17. In the example of FIG. 1A, the indication member 17 is an additional element for indicating the orientations of the body relative to the base. It should be understood that the indication member of the body may also be a part of the body.

The base 12 and the connected body 16 may be placed on a selecting seat 22, as shown in FIG. 1A. FIG. 1A also shows the supporting seat 18 in an adjacent alternate planar surface. The body may also be placed on the supporting seat 18 as shown in FIG. 1B.

In some embodiments, the supporting seat 18 may include within it a second magnetic member 20 (as depicted in dotted outline in FIG. 1A) with a second magnetic field. The first magnetic member 14 may interact with the second magnetic member 20 to move the base 12 and the connected body 16 into a predetermined angular orientation relative to the supporting seat 18.

FIG. 1C depicts a schematic interaction between magnetic fields of the base 12 and the supporting seat 18 of FIG. 1B. Upon placement of the base 12 and connected body on the supporting seat 18, a magnetic interaction occurs between the first magnetic field of the base 12 and the second magnetic field of the supporting seat 18, causing the base 12 (and connected body 16) to rotate on the supporting seat 18 until the magnetic fields reach equilibrium.

In some embodiments, the selecting seat 22 may be sized and dimensioned to fix the position of the base 12 while permitting rotation of the connected body 16 relative to the base 12 by a user to specify one of the plurality of indicating orientations. In some embodiments, the selecting seat 22 may have a recess for receiving a complementary protrusion of the base 12 such that when the base and the body are placed on the selecting seat 22, the rotation of the body relative to the base can easily be achieved by single handed operation by a user.

In some embodiments, the selecting seat 22 may be positioned within a first planar member 26. The first planar member 26 may have a first plurality of regions 26Q. For example, as shown in FIG. 1A, the plurality of regions of the first planar member 26 are labelled as Q1, Q2, Q3, Q4, Q5 and Q6, respectively. These regions may be separate regions on the surface of the first planar member 26 or separate sections of the first planar member 26. Each region or section may display or have at least one indicium.

The supporting seat 18 may be positioned within a second planar member 28. The second planar member 28 may comprises a second plurality of regions 28A. For example, as shown in FIG. 1A, the plurality of regions of the first planar member 26 are labelled as A1, A2, A3, A4, A5 and A6, respectively. These regions may be separate regions on the surface of the second planar member 28 or separate sections of the second planar member 28. Each region or section may display or have at least one indicium located thereon or therein.

In use, the body 16 and the base 12 are placed on the selecting seat 22 by a user. The user may rotate the body relative to the base 12 so that the indicating member indicates or specifies or points toward a region of the first planar member 26.

When the base 12 and the connected body 16 are placed on the supporting seat 18, the first magnetic field of the base 12 interacts with the second magnetic field of the supporting seat 18 such that the base 12 and the connected body 16 are urged by the magnetic field to rotate relative to the supporting seat into a predetermined angular orientation. Therefore, the body 16 (and hence the indicating member) is aligned with one of the second plurality of regions of the second planar member 28. During this rotation, it would be appreciated that the indicating orientation of the body in the selecting seat and the supporting seat relative to the base is substantially unchanged by the user.

In some embodiments, each indicium of the first plurality of regions 26Q may have a corresponding indicium in the second plurality of regions 28A, constituting a pre-determined pair of indicia. The pre-determined pair of indicia may be indicated by the indicating orientation of the body 16 in the selecting seat 22 and the indicating orientation of the body 16 in the supporting seat 18. When the body is in the selecting seat, the indicating orientation of the body 16 is pointing towards a first region of the first plurality of region 26Q, and when the body is in the supporting seat 18, the indicating orientation of the body 16 is pointing towards a second region of the second plurality of regions 28A. The indicating orientation of the body 16 may be denoted by the indicating member 17 of the body 16.

In some embodiments, the indicium in the second plurality of regions 28A and the corresponding indicium of the first plurality of regions 26Q may be located at a different or the same angular orientation relative to the seat (either or both of the selecting seat or supporting seat).

For example, where indicium Q1 corresponds to indicium A1, and indicium Q2 corresponds to indicium A2 . . . as shown in FIG. 1A and FIG. 1B, the indicium labelled as Q1 and Q2 are located at a different angular orientation relative to the seat (i.e., the selecting seat or supporting seat) as compared to the indicium labelled as A1 and A2, respectively.

In some embodiments, each first planar member 26 can be designed to be operated in conjunction with different and distinct second planar members 28. As discussed below; this means that the same question could potentially be used with different answer arrangements (and user adjusted orientations of the second magnetic member 20 as described further herein).

Each of the multiple second planar members 28 may be featured with distinct arrangements of indicia. These varied configurations enhance the play value and engagement when children interact with these toys. The number, position, and arrangement of indicia on both planar members can be customized to create different difficulty levels and learning experiences.

In some embodiments, the pre-determined pair of indicia comprising one indicium of the first set of indicia on the first planar member and one indicium of the second set of indicia on the second planar member are semantically linked. For example, each indicium of the first plurality of regions 26Q is a question and each indicium of the second plurality of regions 28A is a semantically linked answer. For example, the indicium “Q1” is “what is the largest species of big cat?” and the corresponding indicium “A1” is “cheetah”.

It should be understood that other semantic pairings for the pre-determined pair of indicia are also available without limitation. The versatility of these arrangements not only maintains children's interest but also provides opportunities for developing pattern recognition, spatial awareness, and problem-solving skills through play.

The body 16 may be provided in a variety of different shapes. In some embodiments, the body 16 may be in a shape of a robot as shown in FIG. 2A. The body may be in other shapes, such as a panda as shown in FIG. 2C or a pencil as shown in FIG. 2D. It should be understood that other shapes of the body are also available. In an optional embodiment, the body may be releasably connected to the base. This arrangement enables the user to change other types of the body which they prefer.

FIG. 2B depicts an exemplary exploded view of the body 16 of FIG. 2A. The body 16 may be formed by two parts 16a, 16b. The base 12 may have a protruding element 30. The bottom of the body is sized and shaped to engage with the protruding element 30 of the base 12; to support, and engage the body as it is moved by the user to change the orientation of the body relative to the base as it is grasped by the hands of the user.

As depicted; the body 16 has an indication member 17. The indication member 17 is additionally attached to the body 16 for indicating orientations of the body relative to the base. It should be understood that the indication member may a part of the body, such as in the example of FIG. 2C, the body 16 may have an indication member 34 which is an extended tongue of the panda.

Alternatively, as depicted in the example of FIG. 2D where the body 16 is in a shape of pencil, an end of the body itself may be an indication member 36.

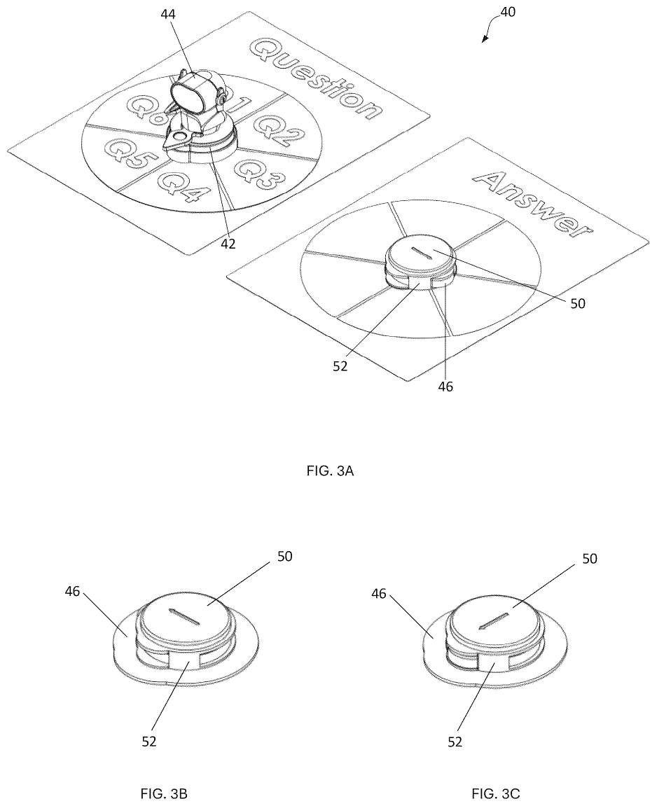

In some embodiments, the orientation of a magnetic member of a supporting member is changeable. FIG. 3A shows a toy system 40. The toy system 40 includes a base 42, a body 44, a supporting seat 46 and a magnetic member 50 which is initially set to orient towards the 3 o'clock position.

The orientation of the magnetic member 50 of the supporting seat 46 is changeable by rotating the magnetic member 50 around the supporting seat 46. For example, the magnetic member 50 may be set to orient towards the 9 o'clock position (as show in FIG. 3B). For another example, the orientation of the magnetic member 50 may be changed to an orientation towards the 6 o'clock position (as shown in FIG. 3C). It should be understood that the direction of the second magnetic member relative to the supporting seat can be selected from a plurality of different directions.

The rotation of the magnetic member may be achieved through a manual turning mechanism where users can directly grasp and rotate the magnetic member within its housing 52 on the supporting seat 46 to achieve a smooth 360-degree movement. For example, the magnetic member 50 may be mounted on a rotatable disc. The rotatable disc is within the housing 52 but may be exposed to users. The magnetic member 50 may be placed within a rotatable enclosure mounted within the housing 52. This rotation can be facilitated by finger grips or indentations on the surface of the magnetic member exposed.

The rotatable disc or the rotatable enclosure may be pre-set to engage at positions corresponding to 3, 6, 9, and 12 o'clock positions. It should be understood that other orientations between these pre-set positions are also available.

In some embodiments, the controlled positioning and rotation of the magnetic member 50 may be accomplished through a curved sliding track integrated into the supporting seat 46. The magnetic member is attached to a carrier that moves along this track, allowing it to be repositioned at different orientations. The track may include pre-set stops at key positions (such as 3, 6, 9, and 12 o'clock), with small detents that provide tactile feedback when the magnetic member is engaged in each position. It should be understood that other orientations between these key positions could also be included.

In some embodiments, the rotation of the magnetic member may be controlled through a simple gear mechanism built into the supporting seat 46. A small gear wheel accessible from the side or top of the supporting seat engages with a larger gear ring attached to the magnetic member. When the user turns the control wheel, it drives rotation of the magnetic member, allowing precise adjustment of orientation. The mechanism may include stops to prevent over-rotation and maintain alignment at desired positions.

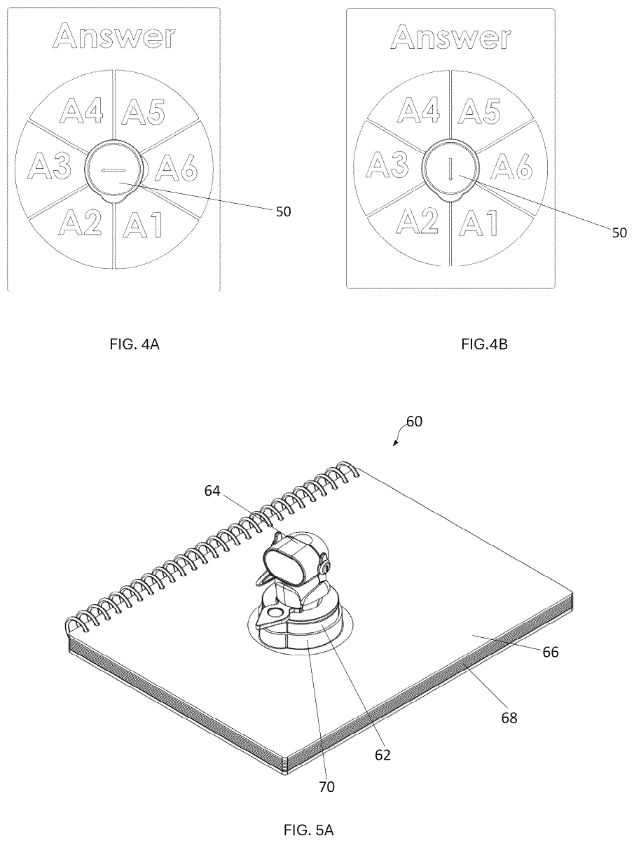

FIG. 4A and FIG. 4B depict exemplary various arrangements of regions of planar members corresponding to the different orientations of magnetic member 50 of FIG. 3B and FIG. 3C.

It should be understood that various alternative methods and mechanisms may exist or be developed for changing the orientation of the magnetic member, and such approaches are intended to be encompassed within the scope of this disclosure.

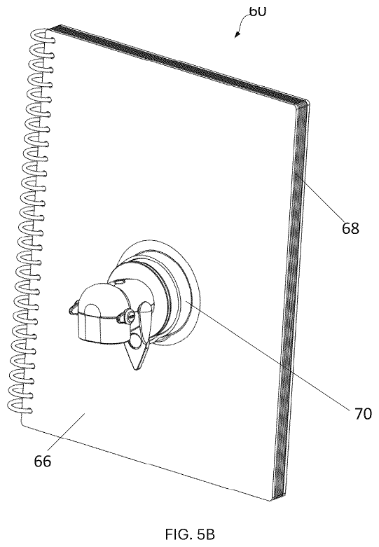

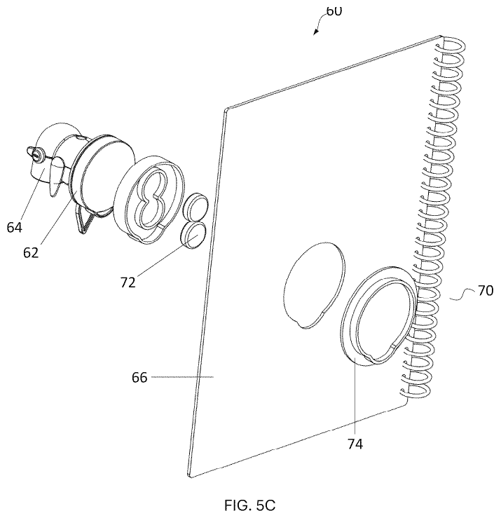

FIG. 5A depicts an alternative embodiment of the toy system 60. The toy system 60 has a base 62 and a body 64. The body 62 may be held on the cover 66 of a book 68 in a horizontal orientation. FIG. 5B shows the body configured to be held on the cover 66 of the book 68 in a vertical orientation.

The cover 66 of the book 68 may comprise a retention member 70 for retaining the base 62 and the connected body 64 on the cover when the book is arranged vertically.

In some embodiments, the retention member 70 may comprise a third magnetic member 72 (as shown in FIG. 5C). In such arrangements, the interaction between the first magnetic member of the base 62 and the third magnetic member 72 may retain the base 62 and the connected body 64 on the cover 66 when the book 68 is arranged vertically. It is also possible that the retention member 70 is made of metal or has a magnetically attracted component, portion or part.

Therefore, the base 62 may be retained by the interaction between the first magnetic member of the base and magnetically attracted component, portion or part of the retention member 70. These arrangements provide secure positioning and prevent accidental dislodgement. The users may transport the book and the connected body from one location to another, allowing for flexibility and portability in their use of the toy system. In a sales context, it enables potential buyers easily visualize the toy systems features and functionality at a glance.

FIG. 5C depicts an exploded view of the cover 66 with the retention member 70 as shown in FIG. 5B. The retention member 70 may be a part of a selecting seat 74 as shown in this example. It should be understood that the retention member 70 may alternatively be a separate configuration as compared to the selecting seat.

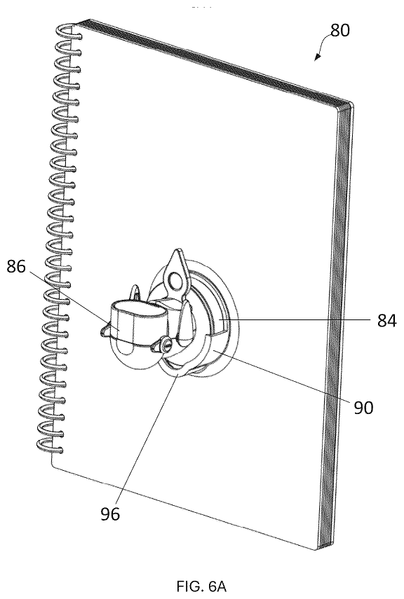

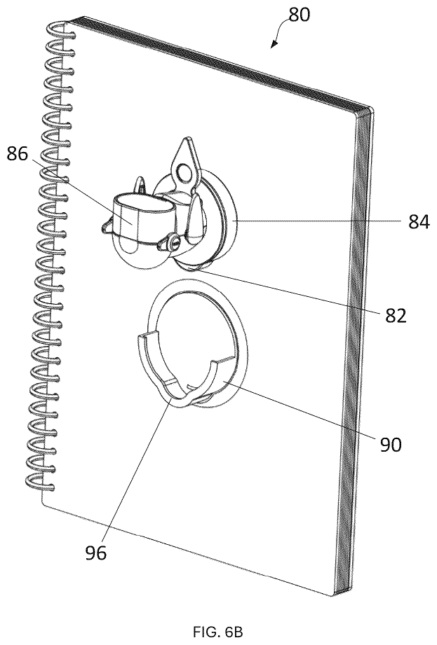

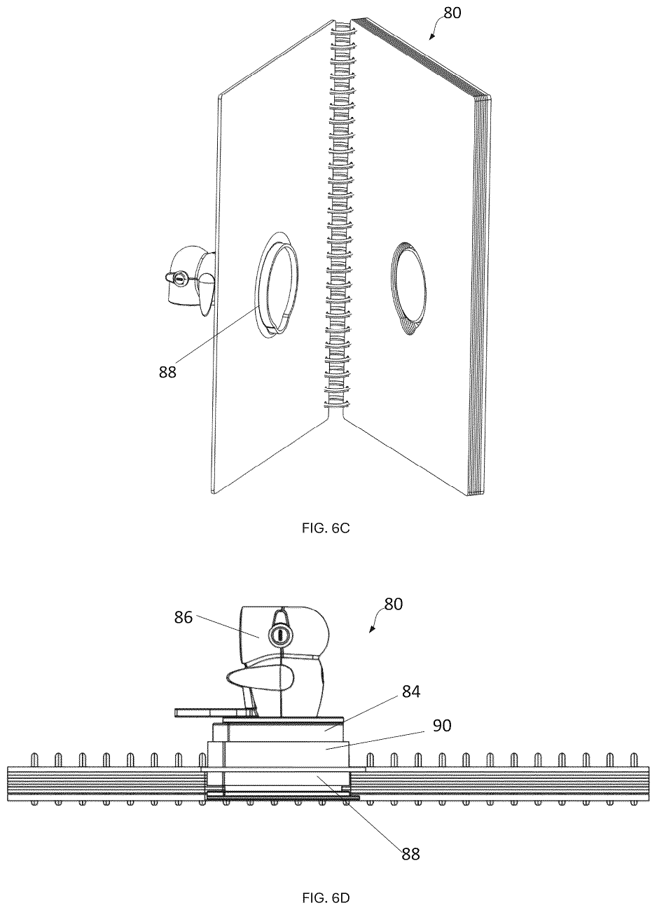

FIGS. 6A-6D depict another embodiment of a toy system 80 in a further aspect of the present disclosure. As depicted; FIGS. 6A and 6B, show the retention member 90 of the toy system 80 may comprise a recess 96 for receiving a complementary protrusion 82 of the base 84. Therefore, the base 84 and the connected body 86 may be retained on the cover when the book is arranged vertically, as shown in FIG. 6A. FIG. 6B shows the body 86 is spaced apart from a holding position. FIG. 6C depicts a partially open view of the toy system 80 of FIG. 6A. In the example of the toy system 80, the retention member 70 is a part of a selecting seat 88.

FIG. 6D is a cross sectional view of the toy system of FIG. 6A.

The toy system of the present disclosure reduces the need for complex mechanical components, making it easier for children to use and maintain. With the present magnetic-based system, children can focus on learning and exploring, without needing to fiddle with intricate mechanisms.

The toy system of the present disclosure provides a unique and innovative approach to learning, offering an accurate, and engaging experience for children. By incorporating an “automatic robot”—magnetic based feature that can provide answers to questions “automatically”, the toy system enables children to guess and check knowledge in a fun and interactive way. The toy system of the present disclosure offers flexibility and customizability, allowing users to easily expand and modify the system to suit their needs. By providing multiple first planar members with diverse types of indicia and corresponding second planar members, children can engage in a wide range of learning experiences that cater to their individual interests and skill levels, including reading, object and image recognition and recall.

The inclusion of multiple second planar members with identical indicia but in different orientations further enhances the system's versatility, enabling users to explore various concepts and ideas from unique perspectives. This allows for seamless integration of new components, ensuring that the toy system remains engaging and challenging as children progress through their learning journey.

By providing a platform for easy customization and expansion, the toy system of the present disclosure empowers children to take ownership of their learning experience, fostering creativity, critical thinking, and problem-solving skills.

The above embodiments are described by way of example only. Many variations are possible without departing from the scope of the disclosure as defined in the appended claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A rotatable toy system, comprising:
a base including a first magnetic member having a first magnetic field
a body connected to the base, the body being rotatable by a user relative to the base to a plurality of indicating orientations,
a supporting seat for rotatably retaining the base and body connected thereto, said seat including a second magnetic member having a second magnetic field,
wherein the first magnetic member interacts with the second magnetic member to move the base and the connected body into a predetermined angular orientation relative to the supporting seat.

2. The rotatable toy system of claim 1, further comprising:
a selecting seat sized and dimensioned to fix a position of the base while permitting rotation of the connected body relative to the base by a user to specify one of the plurality of indicating orientations.

3. The rotatable toy system of claim 2, wherein the selecting seat is positioned within a first planar member having a first plurality of regions defined therein or thereon, said regions displaying at least one indicium, and the supporting seat is positioned within a second planar member comprising a second plurality of regions displaying at least one indicium defined therein or thereon.

4. The rotatable toy system of claim 3, wherein each of the indicium of the first plurality of regions has a corresponding indicium in the second plurality of regions located at a different angular orientation relative to the base.

5. The rotatable toy system of claim 3, wherein following the rotation by the user of the body relative to the base on the selecting seat to specify a region of the first planar member, placement of the base and the connected body on the supporting seat causes the first magnetic field of the base to interact with the second magnetic field of the supporting seat so as to move the base and the connected body into a predetermined angular orientation to align the body with one of the second plurality of regions of the second planar member.

6. The rotatable toy system of claim 5, wherein the indicating orientation of the body in the selecting seat and the supporting seat relative to the base is unchanged.

7. The rotatable toy system of claim 6, wherein a pre-determined pair of indicia is indicated by:
(a) the indicating orientation of the body in the selecting seat denoted by the indicating member of the body pointing towards a first region of the first plurality of region; and
(b) the indicating orientation of the body in the supporting seat denoted by the indicating member of the body pointing towards a second region of the second plurality of regions.

8. The rotatable toy system of claim 1, wherein a direction of the second magnetic member relative to the supporting seat can be selected from one direction from a plurality of different directions.

9. The rotatable toy system of claim 1, wherein the body is releasably connected to the base.

10. The rotatable toy system of claim 7, wherein the pre-determined pair of indicia comprising one indicium of the first set of indicia on the first planar member and one indicium of the second set of indicia on the second planar member are semantically linked.

11. The rotatable toy system of claim 10, wherein the first set of indicia comprise a plurality of questions; and the second set of indicia comprise a plurality of semantically linked answers.

13. The rotatable toy system of claim 3, wherein the first planar member and the second planar member comprise more than one leaves of a book joined together at a spine.

14. The rotatable toy system of claim 13, wherein a cover of the book comprises a retention member for retaining the base and the connected body on the cover when the book is arranged vertically.

15. The rotatable toy system of claim 14, wherein the retention member comprises a portion attracted by the first magnetic member, to retain the base and the connected body on the cover when the book is arranged vertically.

16. The rotatable toy system of claim 14, wherein the retention member comprises a recess for receiving a complementary protrusion of the base and thereby retaining the base and the connected body on the cover when the book is arranged vertically.

17. A rotatable toy system, comprising:
a base including a first magnetic member having a first magnetic field,
a body connected to the base, the body being rotatable by a user relative to the base to a plurality of indicating orientations,
a supporting seat for rotatably retaining the base and body connected thereto, said seat including a second magnetic member having a second magnetic field,
a selecting seat sized and dimensioned to fix the position of the base while permitting rotation of the connected body by a user relative to the base to specify one of the plurality of indicating orientations,
wherein the selecting seat is positioned within a first planar member having a first plurality of regions, said regions displaying at least one indicium, and the supporting seat is positioned within a second planar member comprising a second plurality of regions displaying at least one indicium,
wherein each of the indicium of the first plurality of regions has a corresponding indicium in the second plurality of regions located at a different angular position relative to the base,
wherein following the rotation by the user of the body relative to the base on the selecting seat to specify a region of the first planar member, the placement of the base and the connected body on the supporting seat causes the first magnetic field of the base to interact with the second magnetic field of the supporting seat so as to move the base and the connected body into a predetermined angular orientation to align the body with one of the second plurality of regions of the second planar member.

18. The rotatable toy system of claim 17, wherein the direction of the second magnetic member relative to the supporting seat can be selected from one direction from a plurality of different directions.

19. The rotatable toy system of claim 17, wherein the body is releasably connected to the base.

20. The rotatable toy system of claim 17, wherein the first planar member and the second planar member comprise more than one leaves of a book joined together at a spine.
